(19) United States
(12) Patent Application Publication
(10) Pub. No.: US 2013/0232962 A1
(43) Pub. Date: Sep. 12, 2013

(54) HYDRAULIC CONTROL FOR A VEHICLE POWERTRAIN

(71) Applicant: GM GLOBAL TECHNOLOGY OPERATIONS LLC, Detroit, MI (US)

(72) Inventors: Carlos E. Marin, Oxford, MI (US); Casie M. Bockenstette, Clarkston, MI (US); Paul G. Otanez, Troy, MI (US); Zhen J. Zhang, Canton, MI (US); Min K. Kim, Troy, MI (US); Kristopher J. Kokko, Novi, MI (US)

(73) Assignee: GM Global Technology Operations LLC, Detroit, MI (US)

(21) Appl. No.: 13/717,102

(22) Filed: Dec. 17, 2012

Related U.S. Application Data
(60) Provisional application No. 61/607,152, filed on Mar. 6, 2012.

(51) Int. Cl. F15B 9/00

(52) U.S. Cl. CPC F15B 9/00
USPC 60/327

(57) ABSTRACT

A hydraulic control system and method for controlling a hydraulic system of a vehicle powertrain is provided, which includes an accumulator arranged to accumulate fluid when an engine is turned on, to retain fluid when the engine is turned off, and to discharge fluid to the transmission when the engine is restarted. The accumulator is actively filled through a controlled valve, and it may also be filled passively, for example, via ball check-valve. The method of controlling the hydraulic system includes providing a fluid line pressure to the transmission by opening a fluid passage when the engine is turned on; opening a valve to actively accumulate fluid from the fluid line pressure into an accumulator; closing the valve to retain the fluid in the accumulator; and discharging the fluid from the accumulator to the fluid passage when the engine is restarted.

### CROSS-REFERENCE TO RELATED APPLICATIONS

This application claims the benefit of U.S. Provisional Application No. 61/607,152, filed Mar. 6, 2012, the entire contents of which are incorporated herein by reference.

### FIELD

The present disclosure relates to a system and method for providing fluid to a vehicle powertrain, and more specifically, a system and method for providing fluid to a vehicle powertrain through an accumulator.

### BACKGROUND

The statements in this section merely provide background information related to the present disclosure and may or may not constitute prior art.

A typical automatic transmission includes a hydraulic control system that is employed to lubricate the transmission's moving parts and/or to actuate a plurality of torque transmitting devices. These torque transmitting devices may be, for example, friction clutches and brakes. The conventional hydraulic control system typically includes a main pump that provides a pressurized fluid, such as oil, to a plurality of valves and solenoids within a valve body. The main pump is driven by the engine of the motor vehicle. The valves and solenoids are operable to direct the pressurized hydraulic fluid through a hydraulic fluid circuit to the plurality of torque transmitting devices within the transmission. The pressurized hydraulic fluid delivered to the torque transmitting devices is used to engage or disengage the devices in order to obtain different gear ratios.

In order to increase the fuel economy of motor vehicles, it may be desirable to stop the engine during certain circumstances, such as when stopped at a red light or idling. However, after the engine has been shut down and has remained off for an extended period of time, the fluid generally tends to drain down from the passages into a transmission sump under the force of gravity. Upon engine restart, the transmission may take an appreciable amount of time to establish pressure before full transmission operation may resume.

Therefore, there is a need for a system for accurately controlling the pressure of the hydraulic fluid located within the accumulator to enable proper use of engine start/stop techniques.

### SUMMARY

In some forms of the present disclosure, a vehicle powertrain is provided having an engine capable of being selectively turned on and turned off, and a transmission operatively connected to the engine. The powertrain additionally includes a hydraulic control system with a pump arranged relative to the transmission in fluid communication with the transmission via a structure forming a fluid passage. The pump is operatively connected to the engine for supplying fluid to the transmission when the engine is on, and for being idle when the engine is off. The hydraulic control system also has an accumulator arranged relative to the transmission in fluid communication with the fluid passage. The accumulator is configured to actively accumulate fluid when the engine is on, and in some embodiments, to also passively accumulate fluid when the engine is on. The accumulator is configured to retain the fluid when the engine is turned off and to actively discharge the fluid to the fluid passage when the engine is restarted.

In accordance with another aspect of the present disclosure, which may be combined with or separate from other aspects described herein, a method for controlling a hydraulic system for a vehicle powertrain having an engine and a transmission is also provided. The method includes providing a fluid line pressure via a fluid passage to the transmission by a pump operatively connected to the engine when the engine is turned on, wherein the pump is idle when the engine is off. The method further includes actively accumulating fluid within an accumulator. The method may include passively accumulating fluid when the line pressure in the transmission exceeds the pressure from an accumulated fluid. The method may also include retaining the accumulated fluid when the engine is turned off and discharging the fluid to the fluid passage when the engine is restarted.

In accordance with yet another aspect of the present disclosure, which may be combined with or separate from other aspects described herein, a method of controlling a hydraulic system of a vehicle powertrain having an engine and a transmission is provided. The method includes providing a fluid line pressure to the transmission by opening a fluid passage when the engine is turned on; opening a valve via an electronic controller to actively accumulate fluid from the fluid line pressure into an accumulator when the engine is turned on; closing the valve via the electronic controller to retain the fluid in the accumulator when the engine is turned off; and discharging the fluid from the accumulator to the fluid passage when the engine is restarted such that full transmission operation is afforded substantially without delay.

In accordance with still another aspect of the present disclosure, which may be combined with or separate from other aspects described herein, a method of controlling a hydraulic system of a vehicle powertrain having an engine and a transmission is provided. The method includes providing a fluid line pressure to the transmission by opening a fluid passage when the engine is turned on; opening a solenoid valve to actively accumulate fluid from the fluid line pressure into an accumulator when the engine is turned on; closing the solenoid valve to retain the fluid in the accumulator when the engine is turned off; and discharging the fluid from the accumulator to the fluid passage when the engine is restarted such that full transmission operation is afforded substantially without delay.

In accordance with still another aspect of the present disclosure, which may be combined with or separate from other aspects described herein, a method of controlling a hydraulic system of a vehicle powertrain having an engine and a transmission is provided. The method providing a fluid line pressure to the transmission from a pump by opening a tranmisssion fluid passage when the engine is turned on. The method also includes opening a solenoid valve via an electronic controller to actively accumulate fluid from the fluid line pressure into an accumulator through an active channel when the engine is turned on. Further, the method includes passively accumulating the fluid into the accumulator through a passive channel and a ball check-valve when the fluid line pressure is greater than pressure from the fluid in the accumulator. Further yet, the method includes closing the solenoid valve via the electronic controller to retain the fluid in the accumulator when the engine is turned off. Additionally, the method includes discharging the fluid from the accumulator to the transmission fluid passage through the active channel when the engine is restarted such that full transmission operation is afforded substantially without delay.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram of a portion of an exemplary hydraulic control system, illustrating an accumulator accumulating fluid, in accordance with the principles of the present invention;

FIG. 2 is a schematic diagram of the portion of the exemplary hydraulic control system of FIG. 1, illustrating the accumulator retaining fluid, according to the principles of the present invention;

FIG. 3 is a schematic diagram of the portion of the exemplary hydraulic control system of FIGS. 1-2, illustrating the accumulator discharging fluid, in accordance with the principles of the present invention;

FIG. 4 is a schematic diagram of a portion of another exemplary hydraulic control system, illustrating an accumulator accumulating fluid, in accordance with the principles of the present invention;

FIG. 5 is a schematic diagram of the portion of the exemplary hydraulic control system of FIG. 4, illustrating the accumulator retaining fluid, according to the principles of the present invention;

FIG. 6 is a schematic diagram of the portion of the exemplary hydraulic control system of FIGS. 4-5, illustrating the accumulator discharging fluid, in accordance with the principles of the present invention; and

FIG. 7 is a block diagram illustrating a method for controlling a hydraulic system of a vehicle powertrain, according to the principles of the present invention.

### DETAILED DESCRIPTION

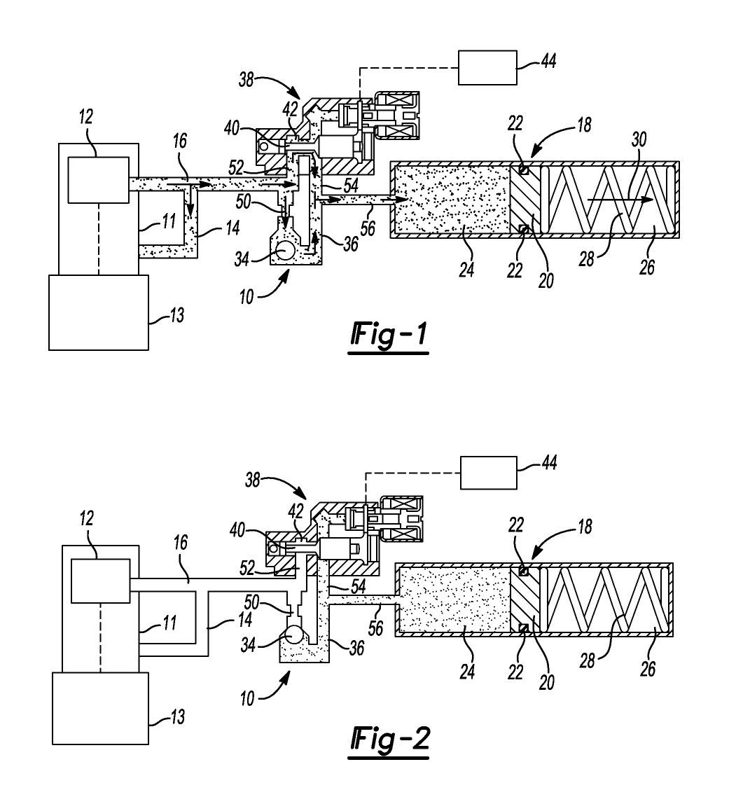

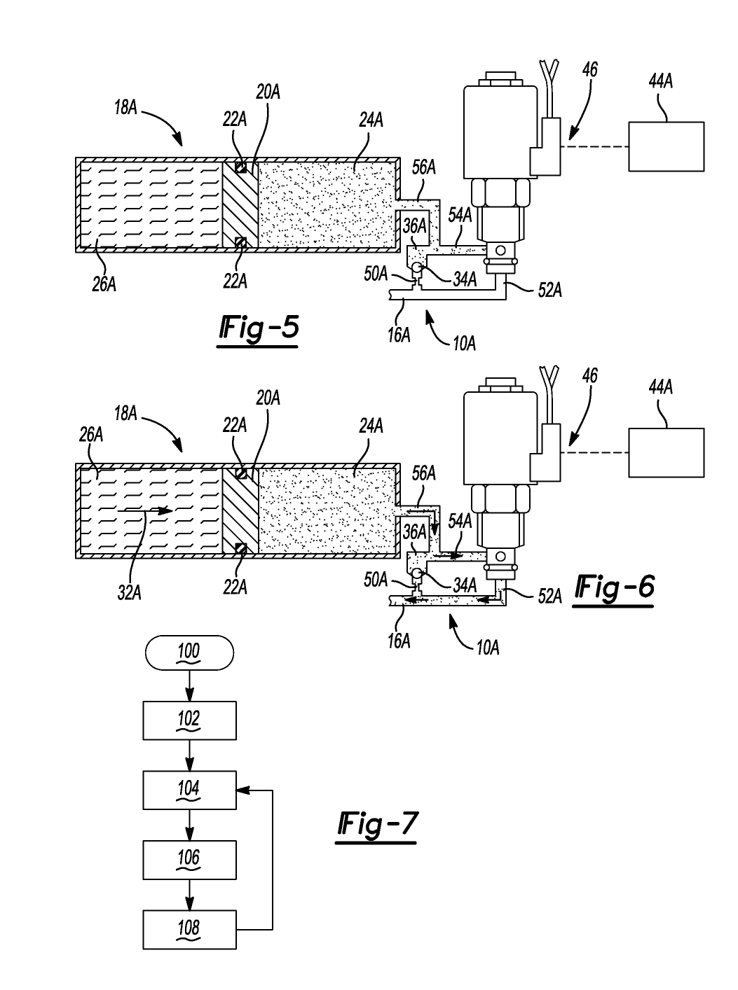

Referring to the drawings, wherein like reference numbers refer to like components, FIGS. 1-6 show a hydraulic control system 10 for a transmission 11 that is connected to an engine 13 in a vehicle powertrain. Generally, a viscous, largely incompressible fluid is utilized in transmissions for cooling and lubrication of moving components, such as gears and bearings. Additionally, in automatic transmissions such a working fluid is also commonly employed for actuating various components that affect gear ratio changes, such as clutches and brakes. The hydraulic control system 10 may be operable to selectively engage the clutches or brakes by selectively communicating a hydraulic fluid, such as automatic transmission fluid, from a sump to a clutch actuation circuit. In FIGS. 1-6, direction of the working fluid flow is represented by arrows.

FIGS. 1-3 show the hydraulic control system 10 utilizing a fluid pump 12 to provide pressurized fluid via a fluid passage 14 to the transmission 11, e.g., to establish transmission line pressure, and via a fluid passage 16 to an accumulator 18. The hydraulic fluid is forced from the sump and communicated throughout the hydraulic control system 10 via the pump 12. The pump 12 may be, for example, a gear pump, a vane pump, a gerotor pump, or any other positive displacement pump. The hydraulic fluid line 16 may include various optional features including, for example, a spring biased blow-off safety valve, a pressure side filter, or a spring biased check valve. Various other components (not illustrated) may be included in the hydraulic control system 10, as is understood in the art.

Fluid passages 14 and 16 may be formed by structures such as a transmission casing, a tube external to the transmission, or otherwise. Fluid pump 12 is operatively connected to the engine 13, i.e., the pump 12 is driven directly by the engine 13 when the engine 13 is on, and is therefore idle when the engine 13 is off.

The accumulator 18 is an energy storage device in which the non-compressible hydraulic fluid is held under pressure by an external source. The accumulator 18 has an internal piston 20 that has a seal 22 that slides along a bore of the accumulator housing, by way of example. The seal 22 may be a hermetic o-ring seal 22 that seals off a pressure cavity 24 from a cavity 26 housing a piston return spring 28. The seal 22 may alternatively have any other configuration suitable for sealing off the working fluid.

On one side of the piston 20 there is hydraulic fluid in a hydraulic cavity 24, and on the other side of the piston 20, there is one or more springs 28 and air, in this embodiment. The accumulator 18 uses a combination of spring(s) 28 and air to generate the force on one side of the piston 20 that reacts against the hydraulic fluid pressure on the opposite side of the piston 20.

Accordingly, the accumulator 18 is operable to supply pressurized fluid back to the hydraulic circuit line 16. The accumulator 18, when charged, effectively replaces the pump 12 as the source of pressurized hydraulic fluid, thereby eliminating the need for the pump 12 to run continuously. Hydraulic fluid is stored in the accumulator 18 at a set volume and pressure while the engine 12 is off.

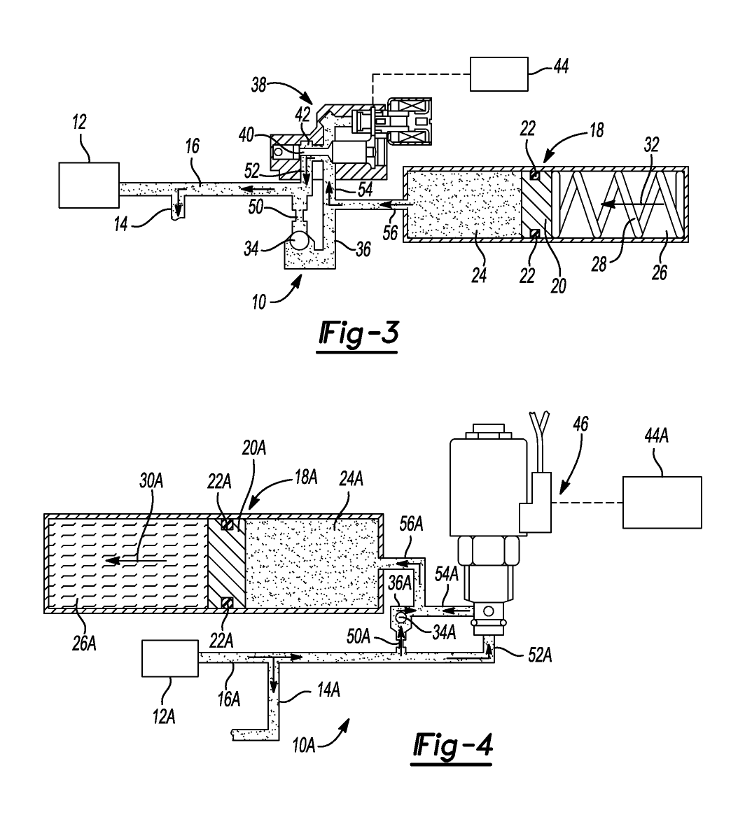

The spring 28 is used to counterbalance a force 30 (shown in FIG. 1) due to the fluid line pressure, and to provide gradual movement of the piston 20 into the cavity 26 when the accumulator 18 is accumulating fluid, i.e. is being filled. The spring 28 is also utilized to provide a piston return force 32 (shown in FIG. 3) when the accumulator 18 is being discharged. Although the accumulator 18 is shown with the piston 20 being supported by the spring 28, other mechanisms may be employed to perform such a function. For example, a compressed gas may be utilized in cavity 26 to pressurize the piston 20 in order to provide the return force 32 for affecting the discharge of the fluid (shown in FIGS. 4-6).

FIG. 1 illustrates the filling of the accumulator 18. In FIG. 1, the fluid flows through the passage 16, to a passive-fill channel 50 and an active-fill channel 52. Through the passive-fill channel 50, the fluid flows past a ball check-valve 34 into a passive accumulator fill channel 36, then into the accumulator passage 56, and from there, into a cavity 24 in the accumulator 18. (In FIG. 2, the check ball 34 is seated, thereby preventing fluid from flowing from the passive accumulator channel 36 and into the passive-fill channel 50, which will be described in further detail below). The ball check-valve 34 is utilized to achieve a passive accumulator 18 fill during transmission operation, in particular when fluid line pressure supplied by the pump 12 is greater than the pressure of the fluid already accumulated in cavity 24.

The filling of the accumulator 18 past the ball check-valve 34 is termed “passive” due to the fact that it takes place automatically, without any outside intervention or support, solely through the unseating of the ball check-valve 34 based on relative pressures on either side of the ball check-valve 34. In other words, when the pressure on the transmission side 11 in line 16 exceeds the pressure in the accumulator 18 and in line 56, the ball check-valve 34 will unseat and allow fluid to flow past the ball check-valve 34 from the passive-fill channel 50 to the passive channel 36. When the fluid pressure is greater in the accumulator cavity 24 and line 56 than in the transmission line 16, however, the ball check-valve 34 will remain seated as shown in FIG. 2. As understood by those skilled in the art, any appropriate mechanism may be utilized in place of the shown ball check-valve 34 to affect a passive accumulator fluid fill in the hydraulic control system 10.

The accumulator 18 may also be filled via the active-fill channel 52. In other words, the accumulator 18 may be filled via the active-fill channel 52, the passive-fill channel 50, or both. If both active and passive filling of the accumulator 18 are used, the active and passive filling may be accomplished simultaneously or serially.

To fill the accumulator 18 through the active-fill channel 52, a latching solenoid 38 opens a poppet valve 40 to cause fluid to flow from the active-fill channel 52 to a channel 54 on the accumulator 18 side of the solenoid 38. The latching solenoid 38 could alternatively be any other suitable type of solenoid or valve, without or without the poppet valve 40. Fluid then flows from the channel 54 to the accumulator channel 56 and into the accumulator cavity 24. As such, the latching solenoid 38 is used to actively fill the accumulator cavity 24, and at the same time, the ball check-valve 34 may be used to passively fill the accumulator cavity 24. Filling of the accumulator cavity 24 is termed “active” because the poppet valve 40 of the latching solenoid 38 is actively controlled to fill the accumulator cavity 24. The poppet valve 40 of the latching solenoid 38 is controlled via an algorithm programmed into an electronic controller 44. The controller 44 governs, i.e. actuates, the latching solenoid 38 to open the poppet valve 40 and introduce fluid from the active-fill passage 52 into the passage 54, thereby feeding the fluid to the accumulator cavity 24.

The passive-fill channel 50 has an orifice that is smaller than both the orifice of the active-fill channel 52 and the orifice of the cavity 42 around the poppet valve 40. This allows the controller 44 to actively fill the accumulator cavity 24. In some embodiments, the passive-fill channel 50, the ball check-valve 34, and the passive accumulator passage 36 could be eliminated so that the accumulator cavity 24 is filled solely by the latching solenoid 38.

In the illustrated embodiment, wherein both active and passive filling of the accumulator cavity 24 are employed, a) the ball check-valve 34 unseats under a pressure differential that is higher in the transmission line 16 than in the accumulator line 56, and b) the poppet valve 40 is moved to allow fluid to flow from the transmission line 16 and the active-fill channel 52, into the poppet valve cavity 42 and past the poppet valve 40. Thus, the fluid from the passage 16 enters the passages 36 and 54 for filling the accumulator 18.

When the line pressure supplied by the pump 12 is not greater than the pressure of the fluid already accumulated in cavity 24, the ball check-valve 34 seats, thus restricting fluid flow to the accumulator 18 (shown in FIG. 2). In addition, when the poppet valve 40 of the latching solenoid 38 is closed (as shown in FIG. 2), the latching solenoid 38 prevents fluid within the accumulator 18 from flowing through the poppet valve cavity 42 and past the poppet valve 40. Fluid cannot flow in either direction past the poppet valve 40 when it is closed. Typically, the line pressure supplied by the pump 12 is less than the fluid pressure inside the cavity 24 either when the pump 12 is off, i.e. when the engine 13 is not powering the pump 12, or when the pressure due to the spring 28 being compressed has risen to the point of being equal to or greater than the line pressure.

To return fluid from the actuator cavity 24 to the transmission line 16, an algorithm causes the controller 44 to actuate the latching solenoid 38 to open the poppet valve 40 and introduce fluid from the accumulator 18 into passage 16, thereby feeding the fluid to various transmission components (not shown) via passage 14. The poppet valve 40 is generally directed to open following a prolonged engine shut down, which typically leads to a transmission fluid drain into a sump (not shown), and a subsequent engine restart. Providing pressurized fluid to the transmission components from the accumulator 18 immediately after an engine restart thereby affords full transmission operation without an otherwise likely delay.

Thus, the latching solenoid 38 is used both for actively filling the accumulator cavity 24 of the accumulator 18 and for discharging fluid from the cavity 24 of the accumulator 18. In other embodiments, separate solenoids can be used to fill and discharge the accumulator 18 respectively, instead of having both functions performed by the same latching solenoid 38 as shown. Additionally, various types of actively actuated devices may be used in place of the latching solenoid 38 to fill and/or discharge the accumulator 18. For example, a two-way valve 46 may be used as shown in FIGS. 4-6.

In some variations, while the solenoid 38 is off, it will block hydraulic fluid from bypassing it, excluding the minute amount of leakage that weeps past the clearances in the parts of the solenoid valve. In this example, when the solenoid 38 is energized electrically, the solenoid 38 opens. The decision to energize the solenoid 38 may be determined based on an engine start command in order to have the clutches/brakes ready for vehicle launch, or it may be based on another command. The hydraulic control system 10 controls the pressure and flow rate to the clutches/brakes to control clutch capacity during the engine start up event to eliminate torque bumps. Once pressure within the main line pressure circuit rises due to the activation of the pump 12, the solenoid 38 is closed electrically, for example, by turning off power to the solenoid 38. The accumulator 18 charge process can start over again to allow for another engine off event or other desired reason for actuation.

FIGS. 4-6 show an alternate hydraulic control system 10A utilizing a two-way, i.e. bi-directional, solenoid valve 46 in place of the latching solenoid 38, and a compressed gas to pressurize the piston 20A and provide the return force 32A. In all other respects, the hydraulic control system 10A shown in FIGS. 4-6 is structured and operates identically to the system 10 shown in FIGS. 1-3, including both a passive-fill channel 50A to fill the accumulator cavity 24A via the ball check-valve 34A and an active-fill channel 52A to fill the accumulator cavity 24A via the bi-directional solenoid valve 46. In addition, like the control system 10 described above, the hydraulic control system 10A has a transmission (not shown) including a pump 12A to provide pressurized fluid via a fluid passage 14A to the transmission and via a fluid passage 16A to the accumulator 18A. The accumulator 18A has an internal piston 20A with a hermetic o-ring seal 22A to seal off the pressure cavity 24A from the cavity 26A housing the compressed gas.

Similar to the system 10, in the system 10A, the bi-directional solenoid valve 46 operates to actively fill the accumulator 18A via the active fill passages 52A, 54A, and the ball check-valve 34A operates to passively fill the accumulator via the passive-fill channels 50A, 36A. The channels 36A and 54A are connected to the accumulator fill channel 56A, which is connected to the accumulator cavity 24A. Fluid is discharged from the accumulator 18A through the two-way valve 46 back to the transmission line 16A. Thus, upon discharge of the accumulator 18A, fluid travels from the accumulator cavity 24A to the accumulator line 56A to the passage 54A, through the valve 46, then to the passage 52A and to the transmission line 16A.

The solenoid or valve device 38, 38A may be an open/close type wherein the valve 40, 38A is either opened or closed, but it is not restricted to this type. In other variations, the displacement of the valve 40, 38A may be varied, so that it may be less than completely open. In other words, the valve 40, 38A may be moved along a continuum from closed to open, such that it has a plurality or continuum of partially open positions. As such, the displacement of the valve 40, 38A may be varied to control the flow rate to or from the accumulator 18, 18A. Thus, the accumulator 18, 18A may be actively filled by varying the displacement of the valve 40, 38A. In some embodiments, the accumulator 18, 18A could simultaneously be filled passively, for example via the ball check-valve 34, 34A, as described above.

In another alternative, the accumulator 18, 18A could be provided with a piston 20, 20A that is loaded both by a spring and by a compressed gas to provide the return force 32, 32A.

A method (shown in FIG. 7) for controlling a hydraulic system of a vehicle powertrain having an engine and a transmission is provided and described with respect to the elements of the hydraulic control system 10 of FIGS. 1-3 or the hydraulic control system 10A of FIGS. 4-6. The method commences in block 100. In block 102 the method includes providing fluid line pressure to the transmission 11 by opening a fluid passage when the engine is on, while no fluid pressure is provided when the engine 13 is off. The fluid pressure may be provided by the pump 12, 12A via fluid passage 14, 14A. As described in relation to FIGS. 1-3, the pump 12, 12A is connected to the engine 13 for being operative when the engine 13 is on, and being inoperative, i.e. idle, when the engine 13 is off.

Proceeding to block 104, according to the method, the fluid is actively accumulated via the accumulator 18, 18A. As described in connection with FIGS. 1-6, the accumulator 18, 18A being in fluid communication with passage 14, 14A via the fluid passage 16, 16A, is filled actively via the latching solenoid 38 or two-way valve 46 through the active-fill channel 52, 54. Thus, the accumulation step 104 includes opening a valve 38, 46 via an electronic controller 44 to actively accumulate fluid from the fluid line pressure into the accumulator 18, 18A when the engine is turned on. In addition, the step 104 may include passively filling the accumulator 18, 18A when the ball check-valve 34, 34A becomes unseated due to the line pressure being greater than the pressure due to the fluid accumulated, i.e. contained, by the accumulator 18, 18A. The accumulator 18, 18A is passively filled through the passive-fill channel 50, 36.

In block 106, the fluid is retained via the accumulator 18, 18A when the engine 13 is turned off due to the latching solenoid 38 or two-way valve 46 remaining closed. Accordingly, the step 106 includes closing the valve 38, 46 via the electronic controller 44 to retain the fluid in the accumulator 18, 18A when the engine is turned off.

In block 108, the fluid is discharged via the accumulator 18, 18A to the fluid passage 16, 16A when the engine 13 is restarted by opening the latching solenoid 38 or two-way solenoid 46 via the controller 44, 44A. The accumulator 18, 18A is discharged when the engine is restarted such a full transmission operation is afforded substantially without delay. The fluid is discharged from the accumulator 18, 18A through the active-fill channel 52, 54.

Subsequent to the engine 13 having been restarted, and the accumulator 18, 18A having discharged its fluid content to the transmission 11, the accumulator 18, 18A is again ready to accumulate fluid to the level dictated by the spring 28 or the gas in the chamber 26A. Accordingly, after block 108, the method returns to block 104 to again accumulate fluid via the accumulator 18, 18A.

Elements of the hydraulic control system 10 of FIGS. 1-3 may be mixed with hydraulic control system 10A of FIG. 4-6, and vice versa. For example, an accumulator 18A having a compressed gas that pressures a piston 20A may be used in a system utilizing a latching solenoid 38; or an accumulator 18 having a spring 28 biasing a piston 20 may be used in a system utilizing a two-way valve 46.

The description of the invention is merely exemplary in nature and variations that do not depart from the gist of the invention are intended to be within the scope of the invention. Such variations are not to be regarded as a departure from the spirit and scope of the invention. In addition, it should be understand that the system and method disclosed herein could incorporate various elements and features that are described throughout the present disclosure, as well as equivalents, without departing from the spirit and scope of the present invention.

1. A method of controlling a hydraulic system of a vehicle powertrain having an engine and a transmission, the method comprising:
providing a fluid line pressure to the transmission by opening a fluid passage when the engine is turned on;
opening a valve via an electronic controller to actively accumulate fluid from the fluid line pressure into an accumulator when the engine is turned on;
closing the valve via the electronic controller to retain the fluid in the accumulator when the engine is turned off; and
discharging the fluid from the accumulator to the fluid passage when the engine is restarted such that full transmission operation is afforded substantially without delay.

2. The method of claim 1, further comprising accumulating the fluid into the accumulator when the fluid line pressure is greater than pressure from the fluid in the accumulator.

3. The method of claim 2, wherein the step of accumulating the fluid into the accumulator when the fluid line pressure is greater than pressure from the fluid in the accumulator comprises passively accumulating the fluid.

4. The method of claim 3, wherein the step of opening the valve via an electronic controller to actively accumulate fluid from the fluid line pressure into an accumulator when the engine is turned on includes accumulating the fluid through an active channel.

5. The method of claim 4, wherein the step of accumulating fluid into the accumulator when the fluid line pressure is greater than pressure from the fluid in the accumulator includes accumulating the fluid through a passive channel.

6. The method of claim 5, wherein the step of accumulating fluid into the accumulator when the fluid line pressure is greater than pressure from the fluid in the accumulator and the step of opening the valve via an electronic controller to actively accumulate fluid are performed simultaneously.

7. The method of claim 6, wherein the step of discharging the fluid from the accumulator to the fluid passage when the engine is restarted includes discharging the fluid through the active channel.

8. The method of claim 7, wherein the valve is provided as a latching solenoid.

9. The method of claim 7, wherein the valve is provided as a two-way valve.

10. The method of claim 7, wherein the step of accumulating the fluid into the accumulator when the fluid line pressure is greater than pressure from an accumulated fluid is performed via a ball check-valve.

11. The method of claim 7, wherein the step of providing the fluid line pressure is performed by a pump operatively connected to the engine, and wherein the accumulator is arranged relative to the transmission in fluid communication with the active channel and the passive channel.

12. The method of claim 11, wherein the accumulator comprises a spring-loaded piston.

13. The method of claim 11, wherein the accumulator comprises a compressed gas loaded piston.

14. The method of claim 11, wherein the accumulator comprises a piston loaded by both a spring and a compressed gas.

15. A method of controlling a hydraulic system of a vehicle powertrain having an engine and a transmission, the method comprising:
providing a fluid line pressure to the transmission by opening a fluid passage when the engine is turned on;
opening a solenoid valve to actively accumulate fluid from the fluid line pressure into an accumulator when the engine is turned on;
closing the solenoid valve to retain the fluid in the accumulator when the engine is turned off; and
discharging the fluid from the accumulator to the fluid passage when the engine is restarted such that full transmission operation is afforded substantially without delay.

16. The method of claim 15, further comprising passively accumulating the fluid into the accumulator when the fluid line pressure is greater than pressure from the fluid in the accumulator.

17. The method of claim 16, wherein the step of opening the solenoid valve to actively accumulate the fluid from the fluid line pressure into an accumulator when the engine is turned on includes accumulating the fluid through an active channel, and the step of accumulating fluid into the accumulator when the fluid line pressure is greater than pressure from the fluid in the accumulator includes accumulating the fluid through a passive channel.

18. The method of claim 17, wherein the step of discharging the fluid from the accumulator to the fluid passage when the engine is restarted includes discharging the fluid through the active channel, and wherein the solenoid valve is opened and closed by an electronic controller.

19. The method of claim 18, wherein the step of providing the fluid line pressure is performed by a pump operatively connected to the engine.

20. A method of controlling a hydraulic system of a vehicle powertrain having an engine and a transmission, the method comprising:
providing a fluid line pressure to the transmission from a pump by opening a tranmisssion fluid passage when the engine is turned on;
opening a solenoid valve via an electronic controller to actively accumulate fluid from the fluid line pressure into an accumulator through an active channel when the engine is turned on;
passively accumulating the fluid into the accumulator through a passive channel and a ball check-valve when the fluid line pressure is greater than pressure from the fluid in the accumulator;
closing the solenoid valve via the electronic controller to retain the fluid in the accumulator when the engine is turned off; and
discharging the fluid from the accumulator to the transmission fluid passage through the active channel when the engine is restarted such that full transmission operation is afforded substantially without delay.
